(19) United States
(12) Patent Application Publication
(10) Pub. No.: US 2026/0254616 A1
(43) Pub. Date: Aug. 27, 2026

(54) INTEGRATED OWNER DIGITAL KEY TRANSFER

(71) Applicant: GM GLOBAL TECHNOLOGY OPERATIONS LLC, Detroit, MI (US)

(72) Inventors: Lingyun Z. Toby, West Bloomfield, MI (US); Mohamed A. Layouni, Macomb, MI (US); Jinzhu Chen, Troy, MI (US); Danielle A. Cory, Brighton, MI (US); Abby Szafranski, Fenton, MI (US)

(73) Assignee: GM GLOBAL TECHNOLOGY OPERATIONS LLC, Detroit, MI (US)

(21) Appl. No.: 19/065,213

(22) Filed: Feb. 27, 2025

(51) Int. Cl. H04L 9/08; H04L 9/14; H04L 9/32

(52) U.S. Cl. CPC H04L 9/0825; H04L 9/14; H04L 9/3247; H04L 9/3263

(57) ABSTRACT

A method for integrated owner digital key transfer includes transferring a key transfer request from a cloud-based vehicle server computer to an old smart device transferring an approval of the key transfer request from the old smart device to the vehicle server computer, transferring the key transfer request from the vehicle server computer to a new smart device, transferring a key signing request from the new smart device to the old smart device, transferring a signed certificate from the old smart device to the new smart device, transferring a transfer import request from the old smart device to the new smart device in response to the signed certificate, transferring the transfer import request from the new smart device to the vehicle, and verifying that the owner digital key is linked to the new smart device.

### INTRODUCTION

The present disclosure relates to a system and a method for integrated owner digital key transfer.

Several steps are currently performed for a customer to enable a different phone as an owner key. Existing owner pairing processes for an initial pairing may be cumbersome and specify that a key fob is presented inside the vehicle for ownership verification. Sometimes, the key fob may not be present when the owner is ready to switch the owner key to the different phone.

Accordingly, those skilled in the art continue with research and development efforts in the field of streamlining user interactions in integrated owner digital key transfers.

### SUMMARY

A method for integrated owner digital key transfer is provided herein. The method includes transferring a key transfer request from a vehicle server computer to an old smart device, where the vehicle server computer is in a cloud, and an owner digital key is linked to the old smart device, transferring an approval of the key transfer request from the old smart device to the vehicle server computer, transferring the key transfer request from the vehicle server computer to a new smart device, transferring a key signing request from the new smart device to the old smart device, transferring a signed certificate from the old smart device to the new smart device, transferring a transfer import request from the old smart device to the new smart device in response to the signed certificate, transferring the transfer import request from the new smart device to a vehicle, and verifying that the owner digital key is linked to the new smart device.

In one or more embodiments, the method further includes transferring the key transfer request from the vehicle server computer to a relay server computer, and transferring a device address of the new smart device from the relay server computer to an old smart device server computer, wherein the old smart device and the new smart device are serviced by different platforms.

In one or more embodiments, the method further includes transferring the device address from the old smart device server computer to the vehicle server computer. The transferring of the key transfer request from the vehicle server computer to the new smart device is based on the device address of the new smart device.

In one or more embodiments, the method further includes placing the owner digital key on hold in the old smart device prior to the transferring of the transfer import request from the old smart device.

In one or more embodiments of the method, the transferring of the transfer import request is routed from the old smart device server computer through a relay server computer prior to being transferred to the new smart device.

In one or more embodiments of the method, the transferring of the transfer import request is routed from the old smart device server computer through a relay server computer prior to being transferred to the new smart device.

In one or more embodiments, the method further includes transferring a key deletion command from the vehicle to the vehicle server computer in response to the verifying that the owner digital key is linked to the new smart device.

In one or more embodiments, the method further includes transferring the key deletion command from the vehicle server computer to the old smart device.

In one or more embodiments of the method, the old smart device is a first smart cellular telephone and the new smart device is a second smart cellular telephone.

A method for integrated owner digital key transfer is provided herein. The method includes transferring a friend key sharing request and a link to a mailbox from an old smart device to a new smart device, submitting a new certificate of the new smart device to the old smart device through the mailbox, returning the new certificate signed by an owner digital key from the old smart device to the new smart device, transferring the new certificate as signed from the new smart device to a vehicle, verifying a friend key in the vehicle in response to the new certificate as signed, transferring an elevate friend key request from the old smart device to the vehicle, setting the friend key as the owner digital key in the vehicle, and transferring the owner digital key from the vehicle to the new smart device.

In one or more embodiments, the method further includes transferring a mailbox creation request from a smart device server computer to a relay server computer, wherein the smart device server computer is in a cloud.

In one or more embodiments, the method further includes transferring a mailbox address of the mailbox from the relay server computer to the new smart device, wherein the link to the mailbox transferred to the new smart device is the mailbox address.

In one or more embodiments, the method further includes registering a new friend key with a vehicle server computer in response to the verifying of the friend key in the vehicle.

In one or more embodiments, the method further includes transferring a friend key sharing status from the vehicle server computer to the old smart device in response to the registering of the new friend key.

In one or more embodiments, the method further includes updating a plurality of key slots in the vehicle in response to the setting of the friend key to the owner digital key in the vehicle.

In one or more embodiments, the method further includes transferring a list of a plurality of old friend keys in the vehicle to the new smart device.

In one or more embodiments of the method, the transferring of the list of the plurality of old friend keys is routed through a smart device server computer.

In one or more embodiments of the method the transferring of the list of the plurality of old friend keys is further routed through a relay server computer.

A vehicle is provided herein. The vehicle includes a transceiver and an electronic control unit. The transceiver is operational to receive a transfer import request. The transfer import request includes a transfer certificate signed by an owner digital key that is linked to an old smart device. The transfer import request is to transfer the owner digital key from the old smart device to a new smart device. The electronic control unit is operational to verify the owner digital key that signed the transfer certificate, store a new public key of the new smart device, delete an old public key of the old smart device from the vehicle, and track the owner digital key.

In one or more embodiments of the vehicle, the transceiver receives the transfer import request from one of (i) a vehicle server computer in a cloud or (ii) a wireless device in proximity to the vehicle.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram illustrating a context of a system in accordance with one or more exemplary embodiments.

FIG. 2 is a flow diagram of a cloud-based owner key transfer method in accordance with one or more exemplary embodiments.

FIG. 3 is a sequence diagram of a cross device platform owner key transfer technique in accordance with one or more exemplary embodiments.

FIG. 4 is a sequence diagram of a same device platform owner key transfer technique in accordance with one or more exemplary embodiments.

FIG. 5 is a flow diagram of a vehicle verification process in accordance with one or more exemplary embodiments.

FIG. 6 is a sequence diagram of an elevate friend-to-owner technique in accordance with one or more exemplary embodiments.

FIG. 7 is a schematic diagram of a first step in a method for transforming a friend device into an owner device in accordance with one or more exemplary embodiments.

FIG. 8 is a schematic diagram of a second step in the method for transforming a friend device into an owner device in accordance with one or more exemplary embodiments.

FIG. 9 is a schematic diagram of a third step in the method for transforming a friend device into an owner device in accordance with one or more exemplary embodiments.

FIG. 10 is a schematic diagram of a fourth step in the method for transforming a friend device into an owner device in accordance with one or more exemplary embodiments.

FIG. 11 is a schematic diagram of a fifth step in the method for transforming a friend device into an owner device in accordance with one or more exemplary embodiments.

FIG. 12 is a flow diagram of a user interaction method in accordance with one or more exemplary embodiments.

FIG. 13 is a flow diagram of another user interaction method in accordance with one or more exemplary embodiments.

### DETAILED DESCRIPTION

Embodiments of the disclosure provide a system and/or method for integrated owner digital key transfers for a vehicle among smart devices. The system/method includes a cloud-based ownership verification and user interaction flows. In various embodiments, the cloud-based ownership verification generally includes a use of a vehicle original equipment manufacturer (OEM) cloud-based server computer to register new owner digital keys, signed by an old owner key, to the vehicle. In some embodiments, the cloud-based ownership verification is used as a preliminary step before to elevating a friend digital key to the owner digital key. In still other embodiments, the cloud-based ownership verification includes a vehicle verification process. The vehicle verification process is performed within the vehicle.

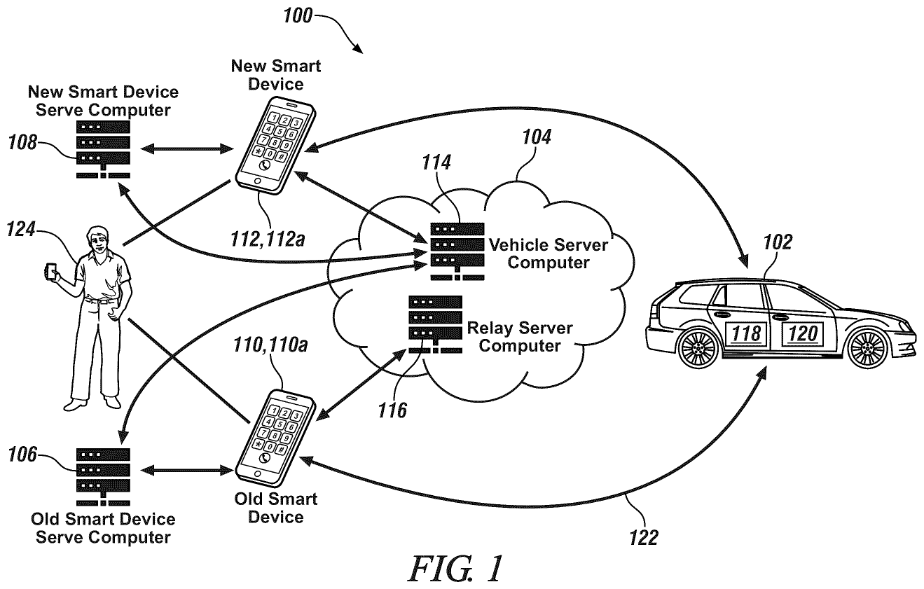

Referring to FIG. 1, a schematic diagram illustrating a context of a system 100 is shown in accordance with one or more exemplary embodiments. The system 100 generally includes a vehicle 102, cloud computing resources 104, an old smart device OEM server computer 106, an optional new smart device OEM server computer 108, an old smart device 110, and a new smart device 112. The cloud computing resources 104 includes a vehicle OEM computer server 114 and an optional relay server computer 116. The vehicle 102 includes a transceiver 118 and an electronic control unit 120 (ECU).

The old smart device 110 is in wireless communications with the vehicle 102, the old smart device server computer 106, the vehicle server computer 114 and the relay server computer 116. The new smart device 112 is in wireless communications with the vehicle 102, the new smart device server computer 108, the vehicle server computer 114 and the relay server computer 116. The vehicle 102 is in wireless communication with the vehicle server computer 114. The old smart device server computer 106 is in communications with the vehicle server computer 114. The new smart device server computer 108 is in communications with the vehicle server computer 114. An owner digital key 122 initially links the vehicle 102 to the old smart device 110. The owner digital key 122 provides a user 124 with access to, control of, and locking the vehicle 102. The owner digital key 122 is transferrable to the new smart device 112.

In various embodiments, the smart devices 110 and 112 are wireless digital communication devices. The smart devices 110 and 112 may include, but are not limited to, smart cellular telephones 110a and 112a, smart watches, personal digital assistances, netbooks, notepads, laptop computers, desktop computers, key fob, and the like. Other types of smart devices may be implemented to meet the design criteria of a particular application. In some situations, the smart device 110 and the smart device 112 may be serviced by a common smart device server computer (e.g., the old smart device server computer 106). In other situations, the smart device 110 and the smart device 112 may be serviced by different smart device server computers. The “old” smart device 110 generally refers to a device initially (or currently) holding the owner digital key 122 and subsequently gives up the owner digital key 122 to the new smart device 112. Thus the owner digital key 122 is transferred from “old” to “new”.

The transceiver 118 is a radio-frequency transceiver. The transceiver 118 is operational to exchange information between the vehicle 102 and the cloud computing resources 104, the old smart device 110 and the new smart device 112.

The ECU 120 includes multiple digital computation circuits. The digital computation circuits may transfer data with one another across a communications bus. The digital computation circuits may be created in hardware, software executing on hardware, or a combination of both. The ECU 120 may receive information from the old smart device 110 and the new smart device 112. The ECU 120 may also exchange data with the vehicle server computer 114.

In various embodiments, the electronic control unit 120 generally includes at least one microcontroller. The at least one microcontroller may include one or more processors, each of which may be embodied as a separate processor, an application specific integrated circuit (ASIC), a field programmable gate array (FPGA), or a dedicated electronic control unit. The at least one microcontroller may be an electronic processor (implemented in hardware, software executing on hardware, or a combination of both). The at least one microcontroller may also include tangible, non-transitory memory, (e.g., read-only memory in the form of optical, magnetic, and/or flash memory). For example, the at least one microcontroller may include application-suitable amounts of random-access memory, read-only memory, flash memory and other types of electrically-erasable programmable read-only memory, as well as accompanying hardware in the form of a high-speed clock or timer, analog-to-digital and digital-to-analog circuitry, and input/output circuitry and devices, as well as appropriate signal conditioning and buffer circuitry.

Computer-readable and executable instructions embodying the present method may be recorded (or stored) in the memory and executed as set forth herein. The executable instructions may be a series of instructions employed to run applications on the at least one microcontroller (either in the foreground or background). The at least one microcontroller may receive commands and information, in the form of one or more input signals from various controls or components and communicate instructions to the other electronic components.

The owner digital key 122 is designed to provide seamless interaction between the user 124 and the vehicle 102 for smooth vehicle access. Several owner digital key features of existing digital key systems, such as owner pairing, digital key sharing, and the like are integrated into the system 100. The user 124 has several manual steps to replace the old smart device 110 with the new smart device 112. The system 100 provides several integrated solutions to smoothly transfer the owner digital key 122 from the old smart device 110 to the new smart device 112, without significant effort and interactions on the part of the user 124, while ensuring the security of such key transfers. The key transfers may be intuitive owner key transfers with a unique digital key user experience. For simplicity, the user 124 is not obligated to start an owner pairing process of the smart devices in the presence of a physical key fob that verifies the ownership.

The user 124 is an owner of the vehicle 102 and the old smart device 110. In various embodiments, the user 124 may also own the new smart device 112. In some situations, the new smart device 112 may belong to a friend of the user 124 who has been given permission to use the vehicle 102.

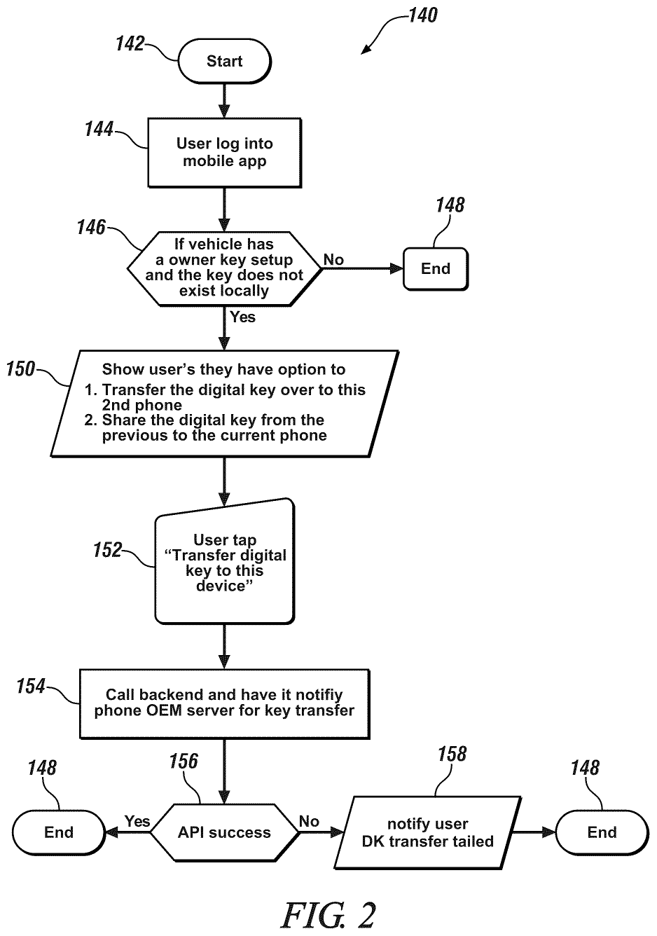

Referring to FIG. 2 with reference back to FIG. 1, a flow diagram of an example implementation of a cloud-based owner key transfer method is shown in accordance with one or more exemplary embodiments. The method (or process) 140 is performed by the system 100. The method 140 includes steps 142 to 158, as illustrated. The sequence of steps is shown as a representative example. Other step orders may be implemented to meet the criteria of a particular application.

The method 140 starts at the step 142. In the step 144, the user 124 logs into his/her account with a mobile application running on the new smart device 112. In the step 146, if the account shows that vehicle 102 has an owner digital key 122 already set up in a different device (old device) and the key does not exist locally in this new device, the method 140 may continue with the step 150. Otherwise, the method 140 ends at the step 148.

In the step 150, the new smart device 110 shows the user 124 multiple (e.g., two) options. A first option is to transfer the owner digital key 122 to the new smart device 112. Another option is to share the owner digital key from a previous (or the old) smart device to the current (or new) smart device. In the step 152, the user 124 selected an option (transfer the owner digital key 122 to the new smart device 112.)

In the step 154, the new smart device 112 issues an application programming interface (API) call to the vehicle server computer 114 of the owner digital key transfer. The vehicle server computer 114 responds by notifying the new smart device 112 that the owner digital key 122 is being transferred. In the step 156, if the API call results in a success, the method 140 ends with the step 148. If the key transfer fails per the step 156, the new smart device 112 notifies the user 124 of the failure in the step 158. Thereafter, the method 140 ends with the step 148.

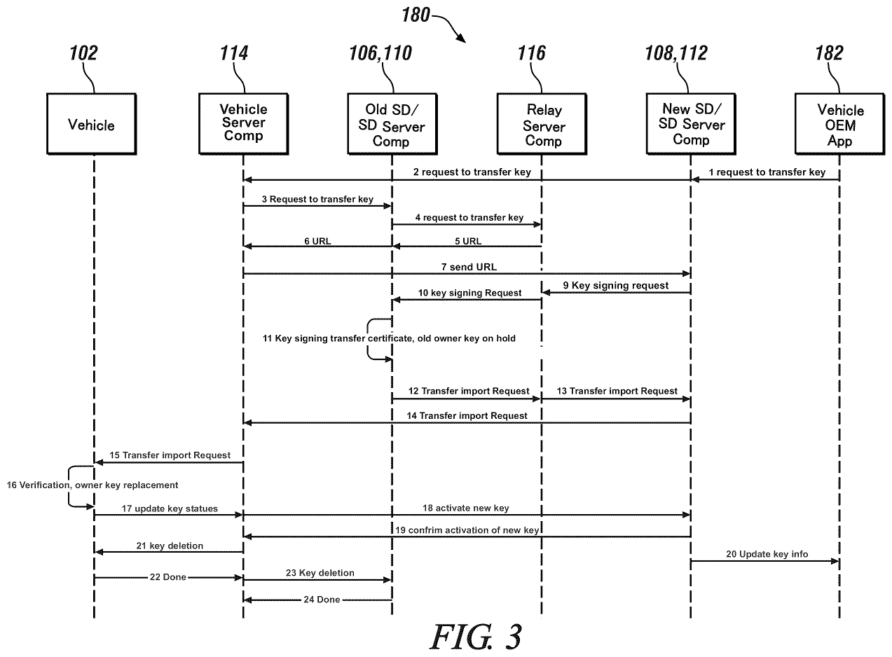

Referring to FIG. 3, a sequence diagram of an example implementation of a cross device platform owner key transfer technique is shown in accordance with one or more exemplary embodiments. The sequence 180 is performed by the system 100. The sequence 180 includes steps 1 to 24, as illustrated. The sequence of steps is shown as a representative example. Other step orders may be implemented to meet the criteria of a particular application. The sequence 180 illustrate handshake messages for an owner key transfer when different smart device OEM server computers are involved.

In step 1, the vehicle OEM app 182 in the new smart device 112 may generate a request for a key transfer. The new smart device 112 then sends the request to the vehicle server computer 114 in the step 2. If the request is valid, the vehicle server computer 114 sends a request to the old smart device 110 to transfer the owner digital key 122 in the step 3. The old smart device 110 is now considered to be the same as the old smart device server computer 106.

If the previous request is valid, in the step 4 the old smart device 110 transfers a key transfer request with transfer information to the relay server computer 116. The relay server computer 116 securely stores the old device key transfer information, assigns a device address (e.g., a universal resource locator (URL)) of the old smart 110, and sends the device address back to the old smart device 110 in the step 5. The old smart device 110 transfers the device address to the vehicle server computer 114 in the step 6.

In the step 7, the vehicle server computer 114 sends the key transfer request to the new smart device 112 with the old device address (URL) received from the relay server computer 116. The new smart device 112 then connects to the old device 110 through the relay server with old smart device's address (URL). The new smart device 112 then reads the key transfer information securely stored on the relay server computer 116 and responds to the key transfer request in the step 9 by transferring a key signing request to the relay server computer 116. In the step 10 the key signing request is transferred from the relay server computer 116 to the old smart device 110.

In the step 11, the old smart device 110 generates a transfer certificate signed by the owner digital key, and places the old owner digital key on hold prior to transferring a transfer import request. The transfer import request with the signed transfer certificate are sent from the old smart device 110 to the relay server computer 116 in the step 12. The relay server computer 116 sends the transfer import request to the new smart device 112 in the step 13.

In the step 14, the new smart device 112 transfers the transfer import request with the signed transfer certificate to the vehicle server computer 114. The vehicle server computer 114 sends the transfer import request to the vehicle 102 in the step 15. In the step 16, the vehicle 102 verifies the signed transfer certificate for the owner digital key replacement. In response to a successful verification, the vehicle 102 sends an update key status to the vehicle server computer 114 in step 17. In step 18, vehicle server computer 114 sends an activation new key request to the new smart device 112. When the new smart device 112 receives the activation, it sends a confirmation back to the vehicle server computer 114 in the step 19. Then, the new smart device 112 sends an update request to the vehicle OEM app 182 in the step 20. When the vehicle server computer 114 receives the confirmation sent in step 19, it sends a key deletion request to the vehicle 102 in step 21. The vehicle 102 then processer the key deletion in the vehicle 102. Once it is finished, the vehicle 102 sends a response to the vehicle server computer 114 in step 22. The vehicle server computer 114 sends the key deletion command to the old smart device 110 in the step 23. Once the old smart device 110 deletes the owner digital key, the old smart device 110 sends a “done” message back to the vehicle server computer 114 in the step 24 to complete the key transfer.

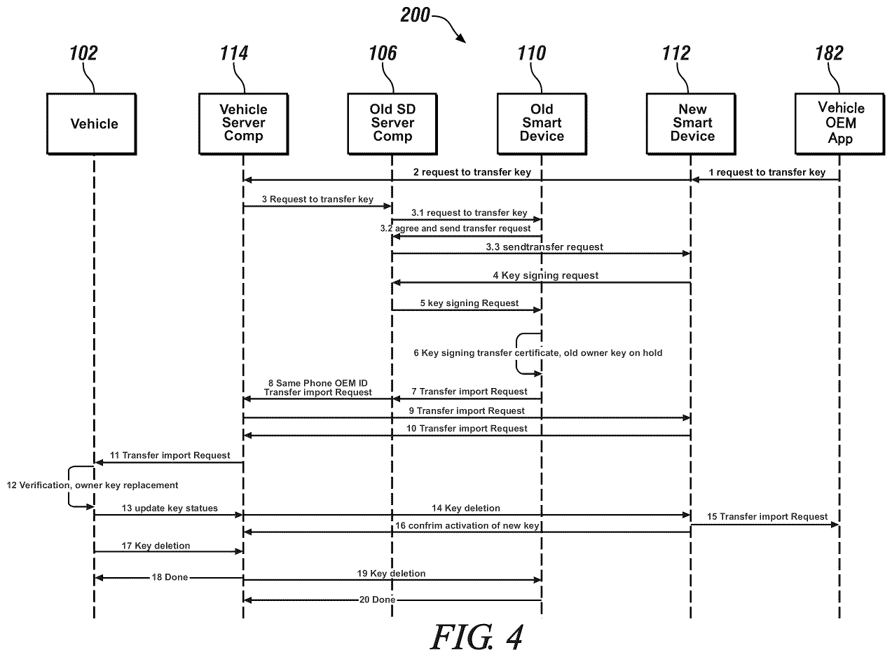

Referring to FIG. 4, a sequence diagram of an example implementation of a same device platform owner key transfer technique is shown in accordance with one or more exemplary embodiments. The sequence 200 is performed by the system 100. The sequence 200 includes steps 1 to 20, as illustrated. The sequence of steps is shown as a representative example. Other step orders may be implemented to meet the criteria of a particular application. The sequence 200 illustrate handshake messages for an owner key transfer when a same smart device OEM server computer (e.g., 106) is involved.

In step 1, the vehicle OEM app 182 in the new smart device 112 may generate a request a key transfer. The new smart device 112 then sends the request to the vehicle server computer 114 in step 2. If the request is valid, vehicle sever computer 114 sends a request to old smart device server computer 106 to request the key transfer in step 3.

In the step 3.1, the old smart device server computer 106 transfers the key transfer request to the old smart device 110. The old smart device 110 responds to the key transfer request in the step 3.2 by sending an agreement back to the old smart device server computer 106. In the step 3.3, the old smart device server computer 106 sends a transfer request to the new smart device 112. In the step 4 a key signing request is sent from the new smart device 112 to the old smart device server computer 106. In the step 5, the key signing request is transferred from the old smart device server computer 106 to the old smart device 110.

In the step 6, the old smart device 110 generates a transfer certificate signed by the owner digital key, and places the old owner digital key on hold. A transfer import request with the signed transfer certificate are sent from the old smart device 110 to the old smart device server computer 106 in the step 7. In the step 8, the transfer import request (same smart device OEM ID) is transferred from the old smart device server computer 106 to the vehicle server computer 114. The vehicle server computer 114 sends the transfer import request to the new smart device 112 in the step 9.

In the step 10, the new smart device 112 transfers the transfer import request with the signed transfer certificate to the vehicle server computer 114. The vehicle server computer 114 sends the transfer import request to the vehicle 102 in the step 11. In the step 12, the vehicle 102 verifies the signed transfer certificate for the owner digital key replacement. In response to a successful verification, the vehicle 102 transfers an update key status instruction to the vehicle server computer 114 in the step 13. The vehicle server computer 114 sends an activate new key command to the new smart device 112 in the step 14. In the step 15, the new smart device 112 notifies the vehicle OEM application 182 of the newly activated key. A confirmation of the new key activation is returned from the new smart device 112 to the vehicle server computer 114 in the step 16. A key deletion instruction is sent from the vehicle 102 to the vehicle server computer 114 in the step 17. Once the vehicle server computer 114 deletes the owner digital key, the vehicle server computer 114 sends a “done” message back to the vehicle 102 in the step 18. A key deletion command is sent from the vehicle service computer 114 to the old smart device 110 in the step 19. Another “done” message is presented from the old smart device 119 back to the vehicle 102 for storage in the step 20 to complete the transfer of the owner digital key to the new smart device 112.

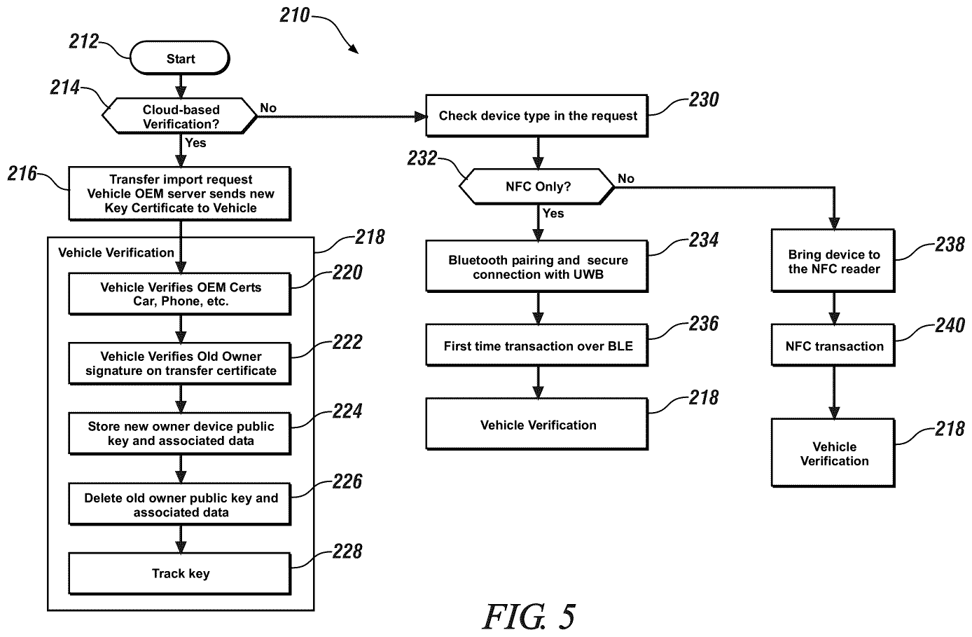

Referring to FIG. 5 with reference back to FIG. 1, a flow diagram of an example implementation of a vehicle verification process is shown in accordance with one or more exemplary embodiments. The vehicle verification process (or method) 210 is performed by the system 100. The method 210 includes steps 212 to 240, as illustrated. The sequence of steps is shown as a representative example. Other step orders may be implemented to meet the criteria of a particular application.

The method 210 starts in the step 212. In the decision step 214, a determination is made if the verification in cloud-based or not. If cloud-based, the method 210 continues with the step 216. In the step 216, the transfer import request with the signed transfer certificate is sent from the vehicle server computer 114 to the transceiver 118 of the vehicle 102. The vehicle verification is performed by steps 220 to 228 within the step 218.

In the step 220, the ECU 120 of the vehicle 102 verifies the certificates, the vehicle 102, the smart devices 110 and 112, and the like. The ECU 120 subsequently verifies the old owner signature on the signed transfer certificate in the step 222. In the step 224, the ECU 120 stores a new owner device public key and associated data. In the step 226, the ECU 120 deletes the old owner public key and associated data. The owner digital key is subsequently tracked by the ECU 120 in the step 228.

If the verification is not cloud based per the step 214, the method 210 continues with the step 230. In the step 230, a check is performed to determine a device type in the transfer import request. A near-field communication (NFC)-only check is performed in the decision step 232. If the communication is not NFC-only, a Bluetooth pairing and secure connection with ultra-wide band (UWB) is performed in the step 234 between the new smart device 112 and the vehicle 102. In the step 236, a first time transaction is performed over the Bluetooth connection to send the transfer import request to the vehicle 102. Thereafter, the vehicle verification step 218 is performed.

If the sending device type is NFC-only per the decision step 232, the new smart device 112 is manually brought into proximity with (e.g., close to) the NFC reader (e.g., in the transceiver 118 or a stand-alone reader) in the step 238. An NFC transaction is performed in the step 240 to send the transfer import request from the wireless device to the vehicle 102. Thereafter, the vehicle verification step 218 is performed.

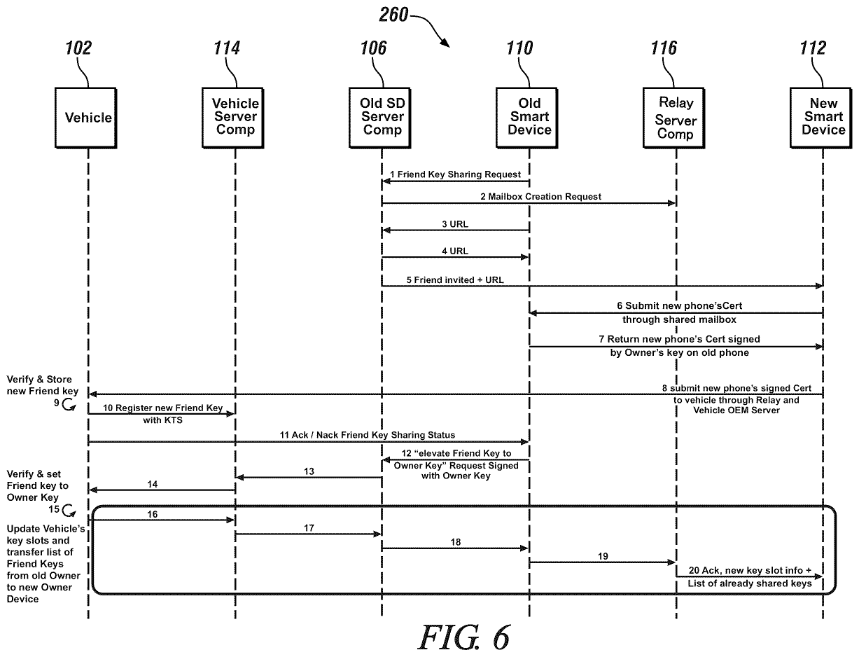

Referring to FIG. 6, a sequence diagram of an example implementation of an elevate friend-to-owner technique is shown in accordance with one or more exemplary embodiments. The sequence 260 is performed by the system 100. The sequence 260 includes steps 1 to 20, as illustrated. The sequence of steps is shown as a representative example. Other step orders may be implemented to meet the criteria of a particular application. The sequence 260 illustrate creating a friend then elevating the friend to the owner.

In step 1, the old smart device 110 may send a friend key sharing request (initiated by the user 124) to the old smart device server computer 106. In the step 2, the old smart device server computer 106 transfers a mailbox creation request to the relay server computer 116. The relay server computer 116 provides a mailbox address (e.g., a URL) of the mailbox back to the old smart device server computer 106 in the step 3. The old smart device server computer 106 transfers the mailbox address to the old smart device 110 in the step 4 for use in a subsequent step 6.

In the step 5, the old smart device server computer 106 sends the friend key sharing request and the mailbox address to the new smart device 112. The new smart device 112 responds to the friend key sharing request in the step 6 by transferring a friend certificate of the new smart device 112 routed through the mailbox to the old smart device 110. In the step 7, the old smart device 110 returns to the new smart device 112 the friend certificate signed by the owners digital key on the old smart device 110.

In the step 8, the new smart device 112 transfers the signed friend certificate routed through the relay server computer 116 and the vehicle server computer 114 to the vehicle 102. In the step 9, the vehicle 102 verifies the signed friend certificate for a friend digital key. In response to a successful verification, the vehicle 102 registers the new friend key with the vehicle server computer 114 in the step 10, and transfers a friend key sharing status to the old smart device 110 in the step 11. The old smart device 110 responds by sending a request to elevate the friend digital key to the owner digital key in the step 12. The request is signed with the owner digital key. The old smart device server computer 106 returns the request to the vehicle service computer 114 in the step 13. In the step 14, the vehicle service computer 114 returns the request to the vehicle 102. The vehicle 102 verifies the signed elevation request in the step 15.

In response to a successful verification, the vehicle key slots are updated and a list of friend keys being transferred from the old smart device 110 to the new smart is sent to the vehicle server computer 114 in the step 16. In the step 17, the vehicle server computer 114 sends the list to the smart device server computer 106. The smart device server computer 106 notifies the old smart device 110 of the updated list in the step 18. The smart device server computer 106 notifies the relay sever computer 116 of the updated list in the step 19. In the step 20, the relay server computer 116 transfers new key slot information and the list of already shared keys to the new smart device 112 to complete the elevation of the friend digital key to the owner digital key in the new smart device 112.

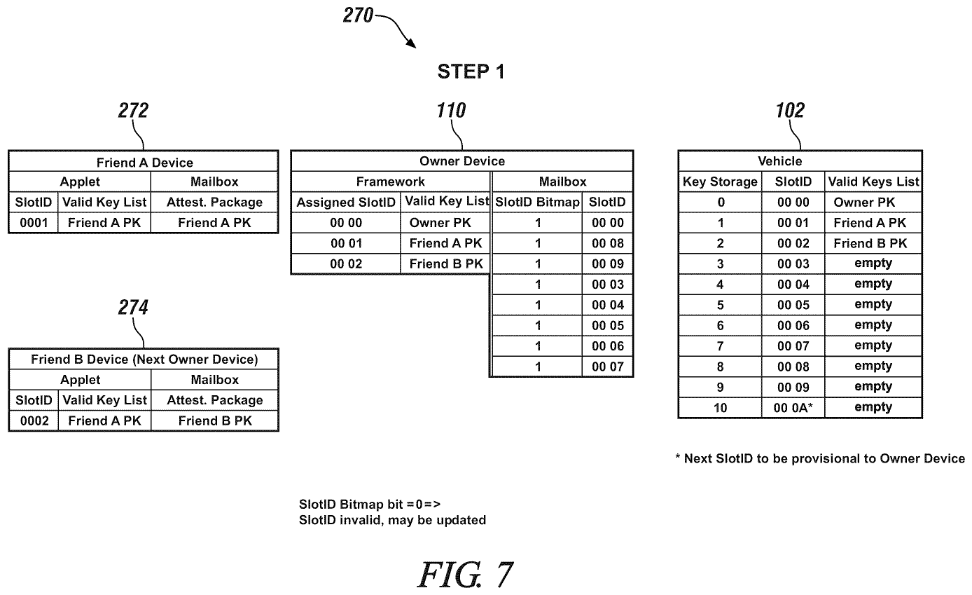

Referring to FIG. 7, a schematic diagram of an example implementation of a first step in a method for transforming a friend device into an owner device is shown in accordance with one or more exemplary embodiments. The method (or process) 270 is performed by the system 100. The method 270 includes steps 1 to 5 as illustrated. The sequence of steps is shown as a representative example. Other step orders may be implemented to meet the criteria of a particular application.

In the step 1, a new friend device 274 (e.g., friend B device) is created. An existing friend device 272 (e.g., friend A device) may already have a friend digital key to the vehicle 102. The friend devices 272 and 274 have storage for applet items and mailbox items. The applet items include a slot identification entry and a valid key list entry. The mailbox items include an attest package entry. The old smart device 110 (e.g., owner device) has storage for framework items and mailbox items. The framework items include multiple assigned slot identifications entries and multiple valid key lists. The mailbox items include multiple slot identification bitmaps and multiple slot identifications. The vehicle 102 has storage for multiple key storage items, multiple slot identifications, and multiple valid key lists. The slot identification in the slotID of the vehicle 102 is shared via the vehicle server computer 114 and the old smart device server computer 106 with the friend B device.

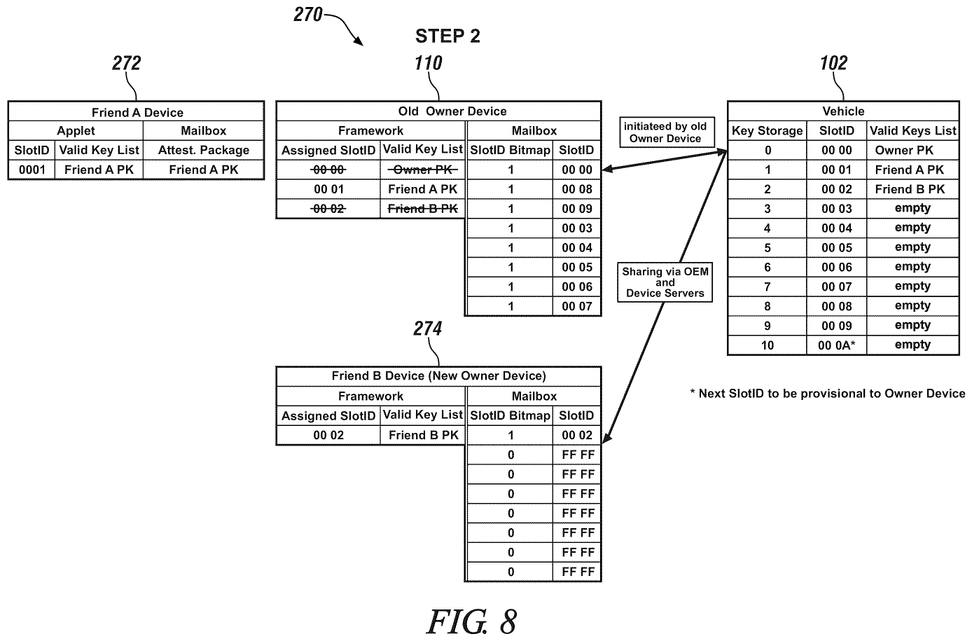

Referring to FIG. 8, a schematic diagram of an example implementation of a second step in a method 270 for transforming a friend device into an owner device is shown in accordance with one or more exemplary embodiments. In step 2, the owner key storage is assigned to the friend B device 274 when initiated by the old owner device (e.g., the old smart device 110). The owner public key (PK) and the friend B public key in framework of the old owner device may be erased. The old owner public key in the valid keys list of the vehicle 102 may be replaced with the friend B public key. The friend B device valid key list is updated to the friend B public key and mailbox is expanded to the slot identification bitmap entries and the slot identification entries as the new owner device. Data in the friend A device 272 is unchanged in step 2.

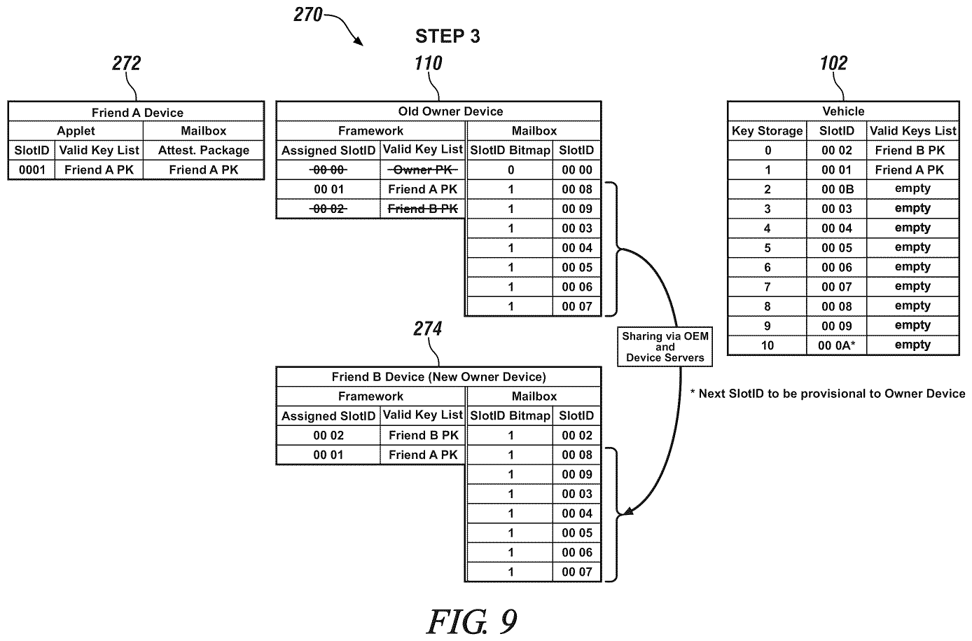

Referring to FIG. 9, a schematic diagram of an example implementation of a third step in a method 270 for transforming a friend device into an owner device is shown in accordance with one or more exemplary embodiments. In step 3, unused slot identifications are copied from the old owner device (e.g., old smart device 110) to the new owner device (e.g., friend B device 274). Data in the vehicle 102 and the friend A device 272 is unchanged in step 3.

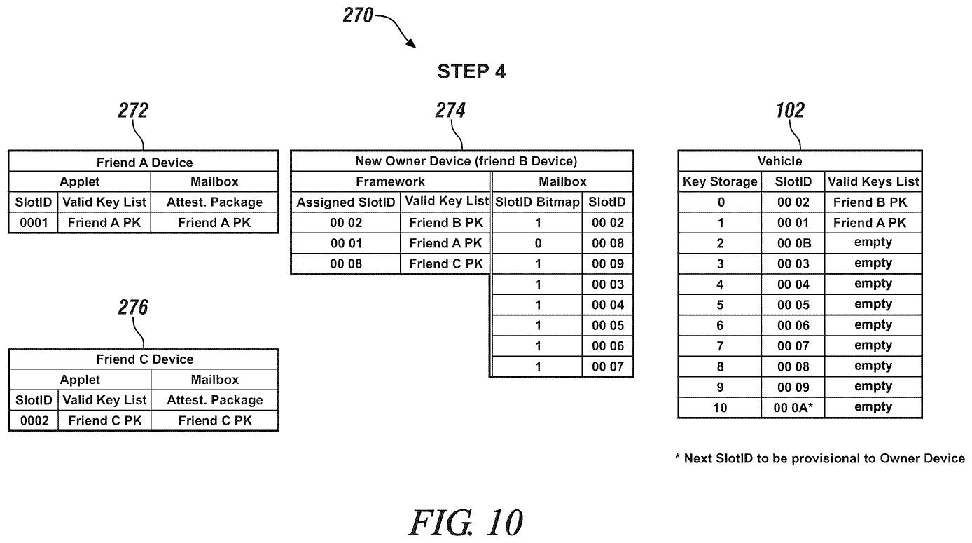

Referring to FIG. 10, a schematic diagram of an example implementation of a fourth step in a method 270 for transforming a friend device into an owner device is shown in accordance with one or more exemplary embodiments. In step 4, the new owner (e.g., friend B device 274) shares the owner digital keys with a friend C device (e.g., friend device 276). The friend C device 276 is recorded in the valid key list of the friend B device 274. The friend C device 276 has storage for applet items and mailbox items. The applet items include a slot identification entry and a valid key list entry. The mailbox items include an attest package entry. Data in the vehicle 102 and the friend A device 272 is unchanged in step 4.

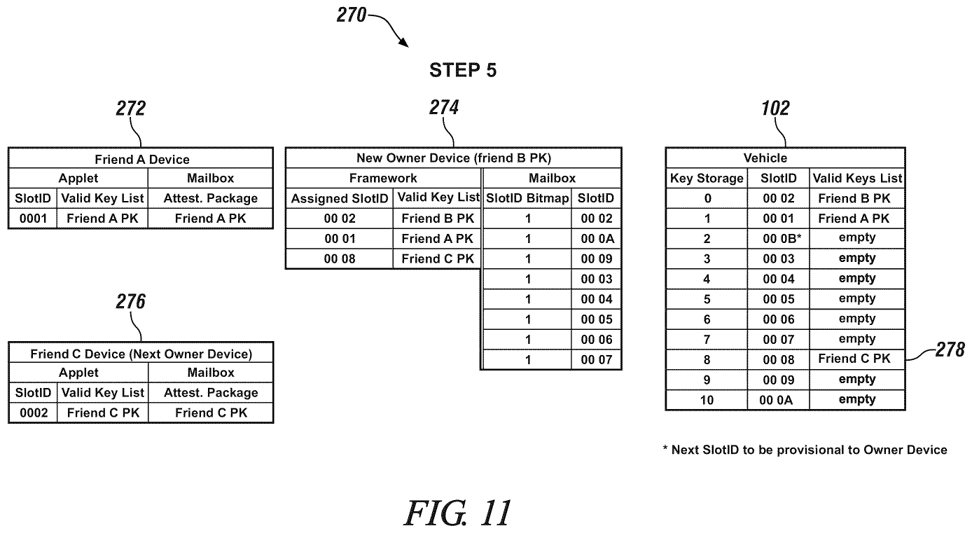

Referring to FIG. 11, a schematic diagram of an example implementation of a fifth step in a method 270 for transforming a friend device into an owner device is shown in accordance with one or more exemplary embodiments. In step 5, the vehicle 102 provisions the new owner device 274 with a new slot ID (e.g., 00 0A) to replace the slot ID (e.g., 00 08) that was assigned to the friend C device 276. The vehicle 102 also increments to next slot ID 00 0B and marks it as the next slot ID to be provisioned. The vehicle 102 is also updated with the new friend sharing. In the example, a friend C public key is added to the valid key list in the vehicle 102 at key storage 8/slot ID 00 08 (see reference 278). Data in the friend A device 272 and the friend C device 276 is unchanged in step 4.

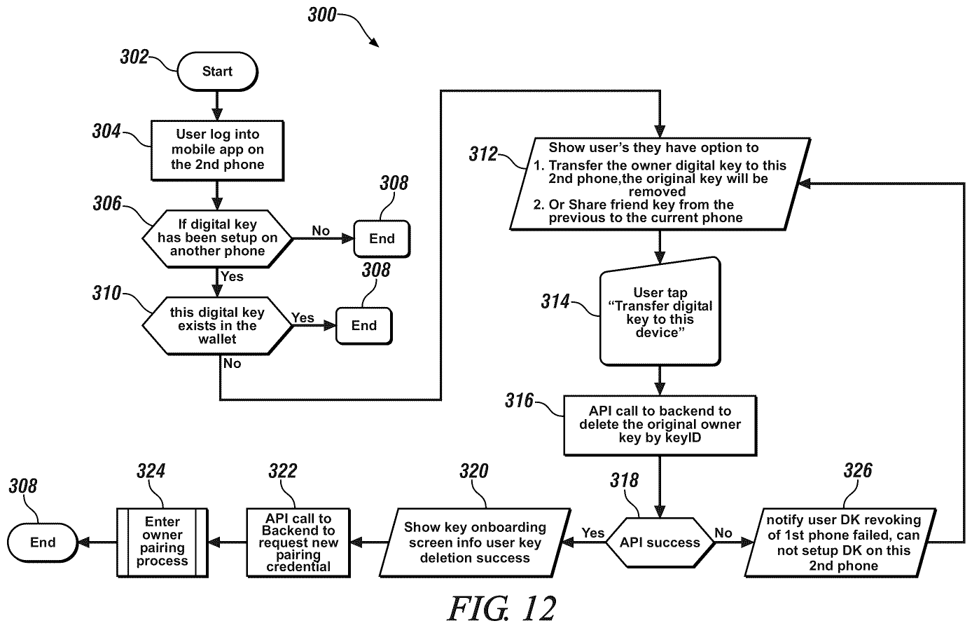

Referring to FIG. 12 with reference back to FIG. 1, a flow diagram of an example implementation of a user interaction method is shown in accordance with one or more exemplary embodiments. The method (or process) 300 is performed by the system 100. The method 300 includes steps 302 to 326, as illustrated. The sequence of steps is shown as a representative example. Other step orders may be implemented to meet the criteria of a particular application. The method 300 is characterized by the absence of the old smart device 110 in transferring the owner digital key to the new smart device 112.

The method 300 starts in the step 302. In the step 304, the user 124 logs in to an application on the new smart device 112. If the owner digital key is not set up on another device (e.g., the old smart device 110) per the decision step 306, the method 300 ends in the step 308. Otherwise, a check is performed in the decision step 310 to determine if the owner digital key exists in a wallet. If not, the method 300 ends in the step 308. If the owner digital key is in a wallet, the method 300 continues with the step 312.

In the step 312, the new smart device 112 shows the user 124 multiple options. A first option is to transfer the owner digital key to the new smart device 112 and the original key is removed. Another option is to share a friend key from a previous smart device to the new smart device 112. The user 124 selects an option in the step 314.

In the step 316, an API call is made to the vehicle server computer 114 to delete the original owner digital key based on the key ID. If the API call was successful per the decision step 318, a key onboarding screen and information that the user key deletion was successful is shown to the user 124 in the step 320. In the step 322, an API call to the vehicle server computer 114 is made to request a new pairing credential. An owner pairing process is entered in the step 324. Thereafter, the method 300 ends with the step 308. If the API call was not successful per the decision step 318, the user 124 is notified in the step 326 that the digital key revoking from the old smart device 110 has failed and so the digital key cannot be set up on the new smart device 112. Thereafter, the method 300 returns to the step 312 to present the options again to the user 124.

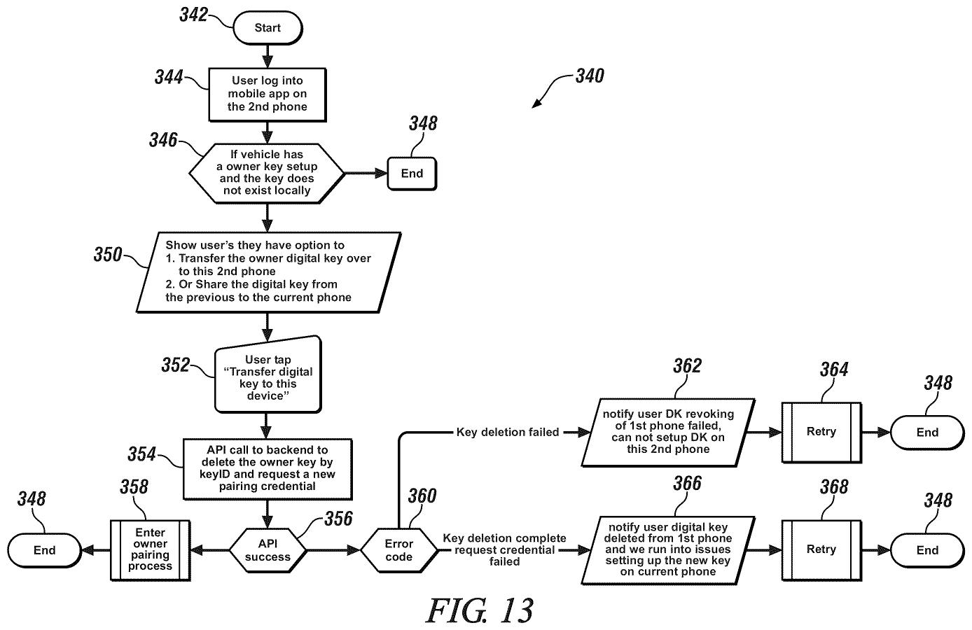

Referring to FIG. 13 with reference back to FIG. 1, a flow diagram of an example implementation of another user interaction method is shown in accordance with one or more exemplary embodiments. The method (or process) 340 is performed by the system 100. The method 340 includes steps 342 to 368, as illustrated. The sequence of steps is shown as a representative example. Other step orders may be implemented to meet the criteria of a particular application.

The method 340 starts in the step 342. In the step 344, the user 124 logs in to an application on the new smart device 112. If the vehicle 102 does not have an owner digital key set up or the key does not exist locally per the decision step 346, the method 340 ends in the step 348. Otherwise, the new smart device 112 shows the user 124 multiple options in the step 350. A first option is to transfer the owner digital key to the new smart device 112. Another option is to share a friend key from a previous smart device to the new smart device 112. The user 124 selects an option in the step 352.

In the step 354, an API call is made to the vehicle server computer 114 to delete the original owner digital key based on the key ID and request a new pairing credential. If the API call was successful per the decision step 356, an owner digital key paring process is entered in the step 358. Thereafter, the method 340 ends with the step 348.

If the API call was returned an error code per the decision step 356, an error code check is performed in the decision step 360. If the error code indicated that the key deletion failed, the user 124 is notified in the step 362 that the digital key revoking failed on the old smart device 110 and so the digital key cannot be set up on the new smart device 112. A retry may be performed in the step 364. If the retry fails, the method 340 ends with the step 348.

If the error code indicated that the key deletion completed and the request for the credential failed, the user 124 is notified in the step 366 that the digital key was deleted from the old smart device 110 and an issue exists with setting up the digital key on the new smart device 112. A retry is performed in the step 368. If the retry fails, the method 340 ends with the step 348.

The cloud-based ownership authentication provides several different handshake protocols which enable cloud-based processes for the old owner smart device to sign a transfer certificate to the new owner smart device. This eliminates the key fob to be physically present during the transferring and automation of the transferring process

Vehicle verification techniques are based on different verification types (e.g., cloud-based or device-based) and device type (e.g., NFC-only or UWB-based). The streamlined user interaction flows provide smart device applications for the user to interact with during the transfers. The elevation of a friend key to an owner key leverage the digital key sharing process. Once the shared key is in the vehicle, the shared key is elevated to become the owner key.

Embodiments of the disclosure generally provide a system and a method for integrated owner digital key transfer. The method includes transferring a key transfer request from a cloud-based vehicle server computer to a smart device server computer, transferring an approval of the key transfer request from the smart device server computer to the vehicle server computer, and transferring the key transfer request from the vehicle server computer to a new smart device. The method further includes transferring a key signing request from the new smart device to the old smart device, transferring a signed certificate from the old smart device to the new smart device, and transferring a transfer import request from the old smart device to the new smart device in response to the signed certificate. The method further includes transferring the transfer import request from the new smart device to the vehicle, and verifying that the owner digital key is linked to the new smart device.

Numerical values of parameters (e.g., of quantities or conditions) in this specification, including the appended claims, are to be understood as being modified in each instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A method for integrated owner digital key transfer comprising:
transferring a key transfer request from a vehicle server computer to an old smart device, wherein the vehicle server computer is in a cloud, and an owner digital key is linked to the old smart device;
transferring an approval of the key transfer request from the old smart device to the vehicle server computer;
transferring the key transfer request from the vehicle server computer to a new smart device;
transferring a key signing request from the new smart device to the old smart device;
transferring a signed certificate from the old smart device to the new smart device;
transferring a transfer import request from the old smart device to the new smart device in response to the signed certificate;
transferring the transfer import request from the new smart device to a vehicle; and
verifying that the owner digital key is linked to the new smart device.

2. The method according to claim 1, further comprising:
transferring the key transfer request from the vehicle server computer to a relay server computer; and
transferring a device address of the new smart device from the relay server computer to an old smart device server computer, wherein the old smart device and the new smart device are serviced by different platforms.

3. The method according to claim 2, further comprising:
transferring the device address from the old smart device server computer to the vehicle server computer, wherein:
the transferring of the key transfer request from the vehicle server computer to the new smart device is based on the device address of the new smart device.

4. The method according to claim 1, further comprising:
placing the owner digital key on hold in the old smart device prior to the transferring of the transfer import request from the old smart device.

5. The method according to claim 4, wherein:
the transferring of the transfer import request is routed through an old smart device server computer prior to being transferred to the new smart device.

6. The method according to claim 5, wherein:
the transferring of the transfer import request is routed from the old smart device server computer through a relay server computer prior to being transferred to the new smart device.

7. The method according to claim 1, further comprising:
transferring a key deletion command from the vehicle to the vehicle server computer in response to the verifying that the owner digital key is linked to the new smart device.

8. The method according to claim 7, further comprising:
transferring the key deletion command from the vehicle server computer to the old smart device.

9. The method according to claim 1, wherein:
the old smart device is a first smart cellular telephone and the new smart device is a second smart cellular telephone.

10. A method for integrated owner digital key transfer comprising:
transferring a friend key sharing request and a link to a mailbox from an old smart device to a new smart device;
submitting a new certificate of the new smart device to the old smart device through the mailbox;
returning the new certificate signed by an owner digital key from the old smart device to the new smart device;
transferring the new certificate as signed from the new smart device to a vehicle;
verifying a friend key in the vehicle in response to the new certificate as signed;
transferring an elevate friend key request from the old smart device to the vehicle;
setting the friend key as the owner digital key in the vehicle; and
transferring the owner digital key from the vehicle to the new smart device.

11. The method according to claim 10, further comprising:
transferring a mailbox creation request from a smart device server computer to a relay server computer, wherein the smart device server computer is in a cloud.

12. The method according to claim 11, further comprising:
transferring a mailbox address of the mailbox from the relay server computer to the new smart device, wherein the link to the mailbox transferred to the new smart device is the mailbox address.

13. The method according to claim 10, further comprising:
registering a new friend key with a vehicle server computer in response to the verifying of the friend key in the vehicle.

14. The method according to claim 13, further comprising:
transferring a friend key sharing status from the vehicle server computer to the old smart device in response to the registering of the new friend key.

15. The method according to claim 10, further comprising:
updating a plurality of key slots in the vehicle in response to the setting of the friend key to the owner digital key in the vehicle.

16. The method according to claim 15, further comprising:
transferring a list of a plurality of old friend keys in the vehicle to the new smart device.

17. The method according to claim 16, wherein:
the transferring of the list of the plurality of old friend keys is routed through a smart device server computer.

18. The method according to claim 17, wherein:
the transferring of the list of the plurality of old friend keys is further routed through a relay server computer.

19. A vehicle comprising:
a transceiver operational to receive a transfer import request, wherein:
the transfer import request includes a transfer certificate signed by an owner digital key that is linked to an old smart device; and
the transfer import request is to transfer the owner digital key from the old smart device to a new smart device; and
an electronic control unit operational to:
verify the owner digital key that signed the transfer certificate;
store a new public key of the new smart device;
delete an old public key of the old smart device from the vehicle; and
track the owner digital key.

20. The vehicle according to claim 19, wherein:
the transceiver receives the transfer import request from one of (i) a vehicle server computer in a cloud or (ii) a wireless device in proximity to the vehicle.
